(19) United States
(12) Patent Application Publication
(10) Pub. No.: US 2023/0393297 A1
(43) Pub. Date: Dec. 7, 2023

(54) Method for Securing Power in Remote Locations and Apparatus Therefor

(71) Applicant: Crone Geophysics Y Exploraton Ltd., Mississauga (CA)

(72) Inventor: Abderrahim Abdelhadi, North York (CA)

(21) Appl. No.: 18/220,411

(22) Filed: Jul. 11, 2023

Related U.S. Application Data
(63) Continuation of application No. 16/975,450, filed on Aug. 25, 2020, now abandoned.
(60) Provisional application No. 62/636,938, filed on Mar. 1, 2018.

(51) Int. Cl. G01V 3/10; G01V 3/08

(52) U.S. Cl. CPC G01V 3/104; G01V 3/081

(57) ABSTRACT

An apparatus with a plurality of power supplies, a generator, a transmitter and a wire loop to the transmitter for mineral exploration and a plurality of single-phase portable AC generators, wherein the plurality of power supplies and plurality of generators are coupled to receive power therefrom as well as the circuitry couples the power supplies to one another and in use with the transmitter.

### FIELD

The invention relates to the field of portable power generation.

### BACKGROUND

It is known to carry out mineral surveys by passing current through a conductor near the ground to be surveyed and taking measurements associated with induced currents in the ground. Systems include, but are not limited to, electromagnetic (EM) systems, Time-domain Electromagnetic (TDEM) system, Induced Polarization (IP) systems and Resistivity systems. Historically, these systems used relatively low amounts of power, but demands have grown, and systems often require 15 kW or more. The requirement to transport 15 kW generators adds to the cost of surveying, especially in remote, mountainous areas.

### SUMMARY OF THE INVENTION

Forming one aspect of the invention is apparatus for use with a load and one or more supplies of power, the apparatus comprising: a power supply for each of said one or more supplies, the power supply being coupled, in use, to said each supply to receive power therefrom; and circuitry coupling the power supplies to one another and, in use, to the load.

According to another aspect, each power supply can be adapted to receive AC power from a generator.

According to another aspect, each power supply can be adapted to receive AC power and produce DC power.

According to another aspect, each power supply can be adapted to receive single phase AC.

According to another aspect, each power supply can be about a 5 kW power supply.

According to another aspect, each power supply can be rated for 170 VDC and 60 A DC.

According to another aspect, the apparatus can be used with a transmitter.

According to another aspect, the transmitter can be about a 15 kW transmitter, producing about 60 A and 500 VDC maximum.

According to another aspect, the transmitter can generate various current waveforms in a wire loop for mineral exploration.

According to another aspect, the loop can be a TDEM loop.

According to another aspect, a generator can be provided for, and define, each supply of power.

Forming another aspect of the invention is apparatus for use with (i) a transmitter coupled to a wire loop for mineral exploration and (ii) one or more single-phase portable AC generators, the apparatus comprising: a power supply for each of said one or more generators, the power supply being coupled, in use, to said each generator to receive power therefrom; and circuitry coupling the power supplies to one another and, in use, to the transmitter.

According other aspects, in this apparatus there can be three, four or five power supplies.

A system including a plurality of DC generators, each DC generator being defined by a portable single phase AC generator and a power supply, the power supply being releasably coupled to said AC generator to receive AC power therefrom and produce DC power, circuitry coupling the DC generators together such that the power supplies thereof are connected in series to define a DC supply, a portable transmitter operatively releasably coupled to the DC supply, and a TDEM loop operatively coupled to the transmitter. In some embodiments, each power supply is a nominal 5 kW power supply adapted to receive single phase AC power and rated for about 60 A and about 170 VDC. In some embodiments, the transmitter has a power of about 15 kW. Each generator may be a 5 or 6 kW single phase AC generator, rated for about 240 VAC and about 20 Amps. A housing may be provided containing the power supplies and the circuitry, the generators and TDEM loop being disposed exterior to the housing. In some embodiments, the transmitter is disposed exterior to the housing. Advantages, features and characteristics of the invention will become evident upon a review of the detailed description, with reference to the appended drawing, the latter being briefly described hereinafter.

### BRIEF DESCRIPTION OF THE DRAWING

FIG. 1 is a block diagram showing an exemplary embodiment of the invention;

FIG. 2 is a view similar to FIG. 1;

FIG. 3 is a view of the waveform produced by the structure of FIG. 2 in use;

FIG. 4 is a closer view of the waveform of FIG. 3;

FIG. 5 shows the linear ramp current turn-off and showing the transmitter in operation at maximum peak current of 60 A;

FIG. 6 shows the linear ramp current turn-off and showing the transmitter in operation at near peak voltage of 1000V and near peak power of 20 kW; and

FIG. 7 shows yet another variant of FIG. 1.

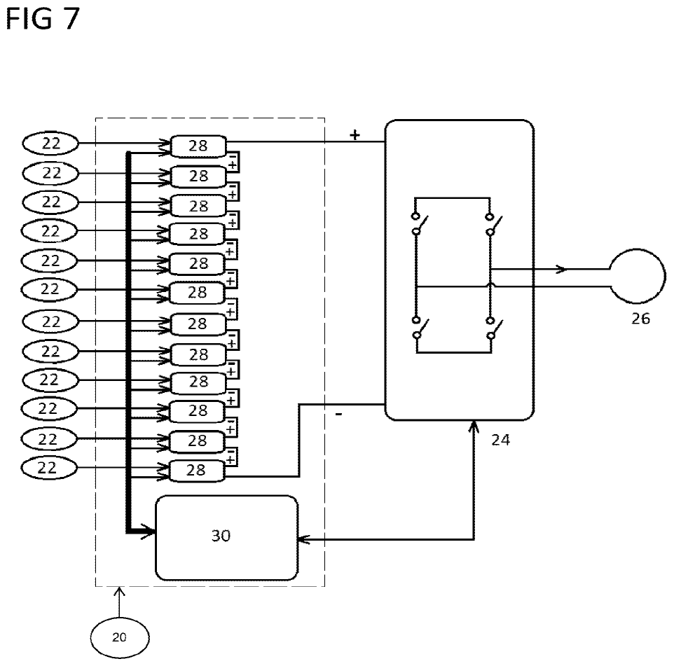

### DETAILED DESCRIPTION

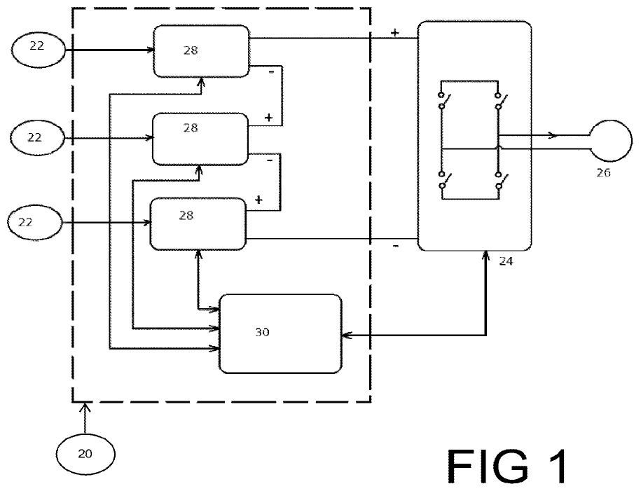

Reference is made to FIG. 1 which shows an exemplary embodiment of the invention in use which will be seen to include: apparatus 20; supplies of power, namely, generators 22; a transmitter 24; and a loop 26.

The apparatus 20 comprises: a power supply 28 provided for each of said generators and adapted to receive power therefrom; and circuitry 30 coupling the power supplies to one another and to the transmitter 24. The circuitry 30 includes a control board based on a processor which provides the necessary signals to control the transmitter and the power supplies.

Each power supply 28 is a nominal 5 kW power supply adapted to receive single phase AC power and produce DC power [170 VDC, 60 A DC max].

Each generator is a 6 kW single phase AC generator, supplying 240V and up to 20 Amps.

The transmitter 24 is a 15 kW transmitter, producing about 60 A and 500 VDC maximum and generates various waveforms.

The loop is a wire loop used for mineral explorations, more particularly, a TDEM loop.

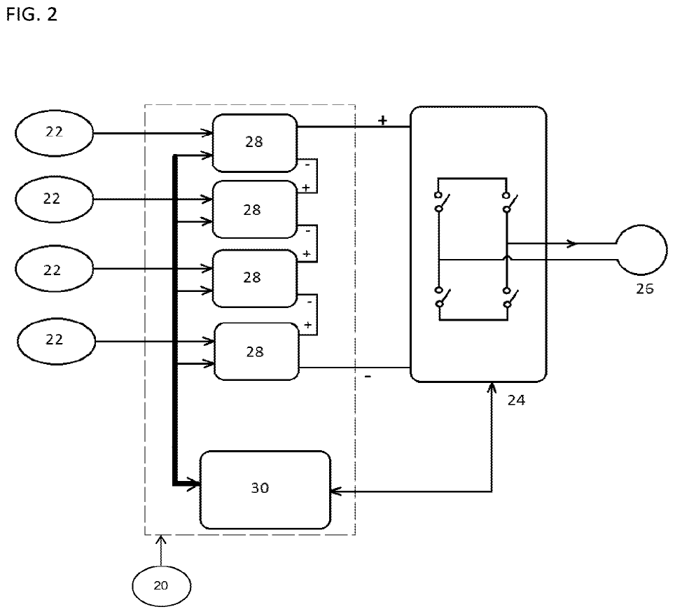

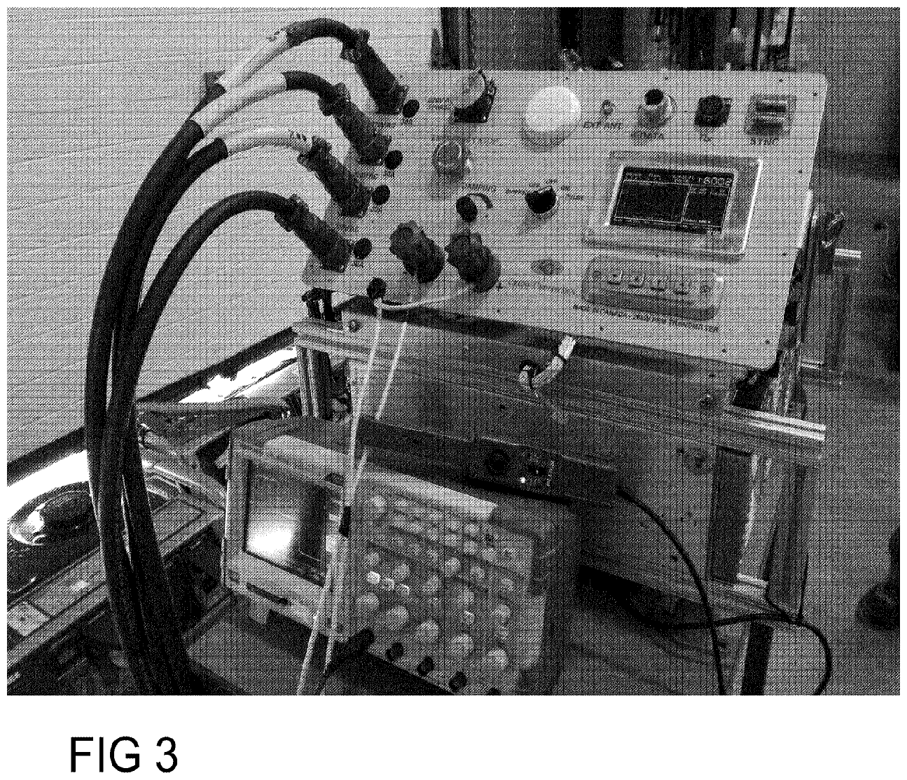

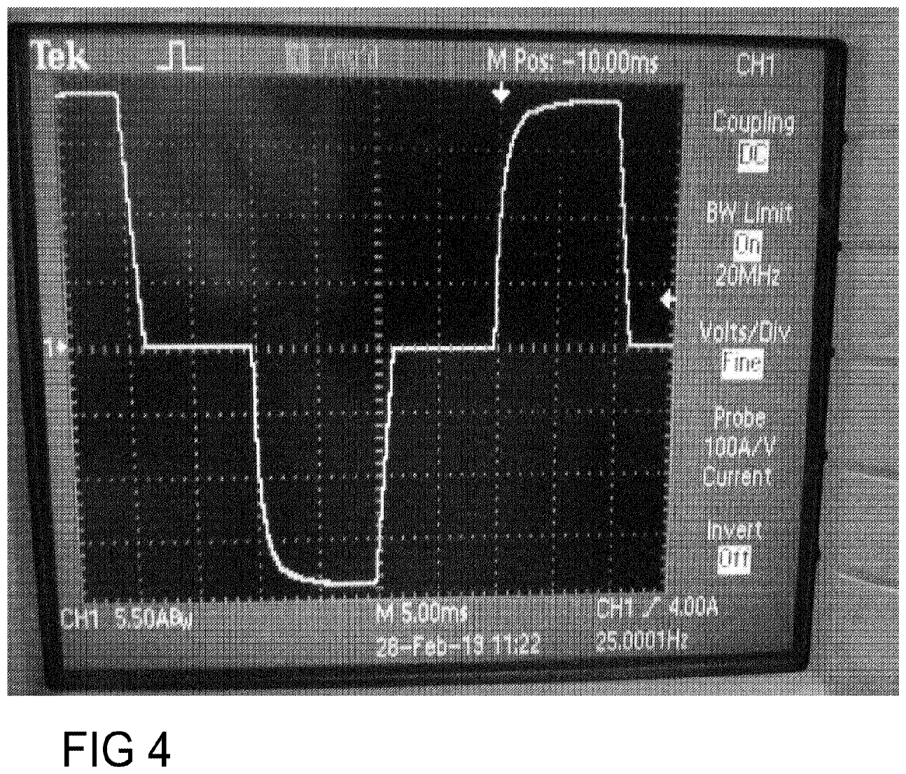

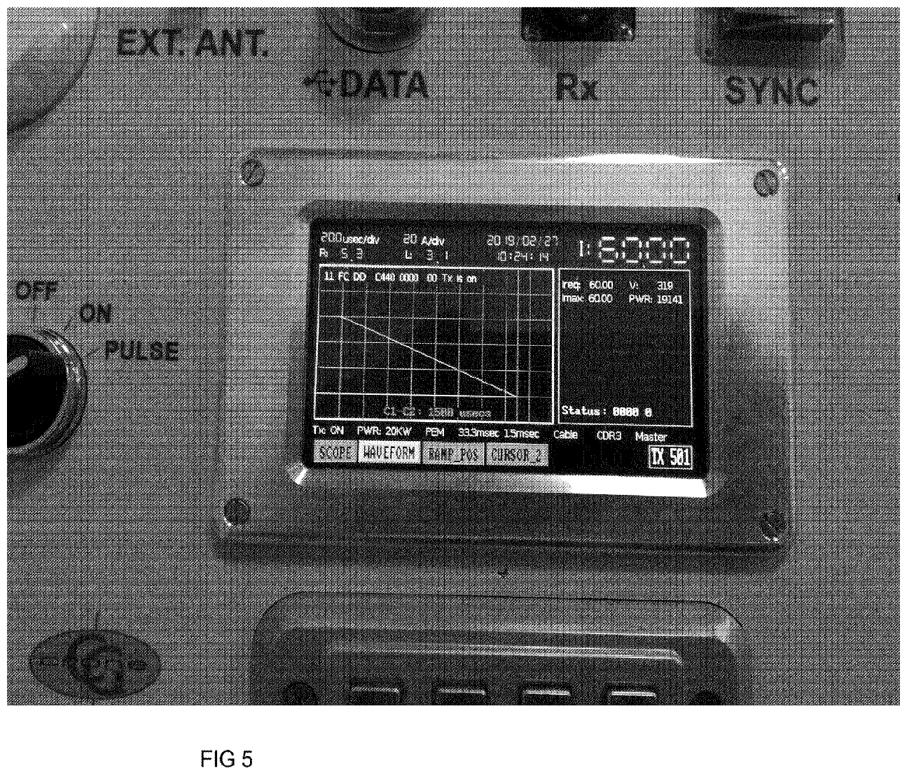

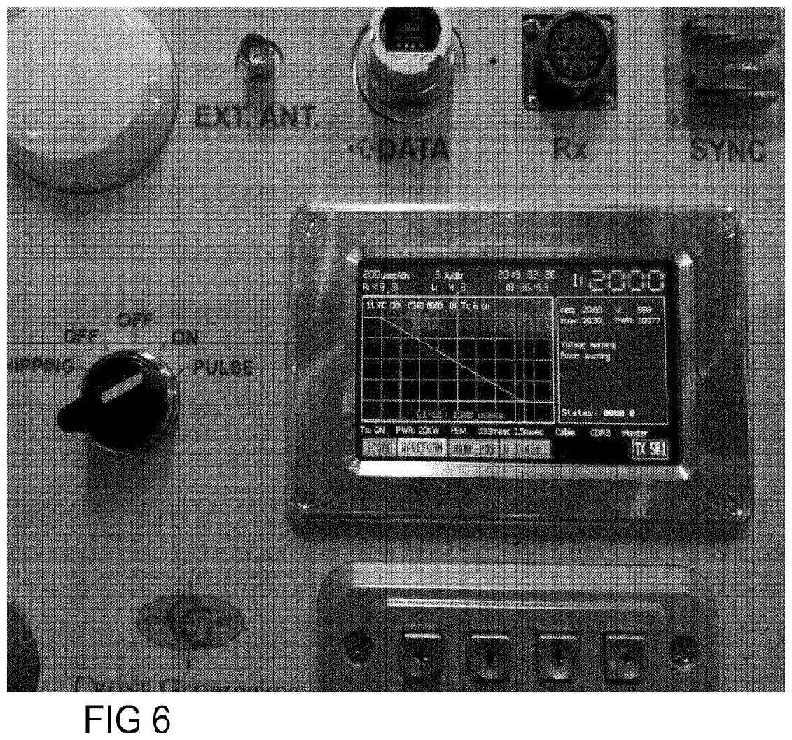

Persons of ordinary skill will readily appreciate that:
5 kW single phase AC generators are standard, off-the shelf units which can be purchased or rented throughout the world. Thus, if desired, a surveyor can ship only the transmitter, apparatus and loop to the destination of interest, and procure generators locally.
carrying a 5 kW generator over rough terrain can be done, if necessary, by two men, whereas carrying a 15 kW generator practically requires mechanical assistance, such as a truck, which can be difficult in rough terrain, or a helicopter, which is very costly
breakdown of a single 15 kW generator in a remote area would be problematic, whereas the likelihood of a problematic generator breakdown could be reduced to manageable levels in the context of the present apparatus merely by carrying a spare 5 kW generator.

Whereas a 15 kw variant is shown in FIG. 1, it will be evident that variations are possible. For example:
FIG. 2 is a view similar to FIG. 1 showing a 20 kw variant, constructed generally similarly to the 15 kW and as such not described in detail;
FIG. 3 is a view of the waveform produced by the structure of FIG. 2 in use;
FIG. 4 is a closer view of the waveform; and
FIG. 5 shows the linear ramp current turn-off and showing the transmitter in operation at maximum peak current of 60 A; and
FIG. 6 shows the linear ramp turn-off and showing the transmitter in operation at near peak voltage of 1000V and near peak power of 20 kW.

Of course, yet further variations are possible. For example, FIG. 5 shows a 60 kw variant, again, constructed generally similarly and as such not described in detail.

Whereas three specific embodiments are shown, further variations are possible.

For example, the input voltage to each power supply can be in the range of 180 to 264 VAC, and at a frequency of 47 to 63 Hz.

As well, where available, a single 3-phase generator can also be used, which would supply power to all three power supplies.

Further, the apparatus can be varied to supply greater or lesser load power using greater or lesser number of differently-sized but widely-available generators [and an equal number of power supplies]. For example, 3.5 kW generators are also widely available such that a 10 kW load could be powered with three generators and a 15 kW load could be powered with five generators.

Yet further, not all power supplies have to be used if the transmitter is not operating at peak power.

Moreover, each power supply does not need to have a dedicated generator. One generator can supply multiple power supplies within the limits of its power output.

Additionally, the voltage limit could be extended to 1,000V, 2,000V, 5,000V or higher, and the current limit could be extended to 100 A, 200 A or higher with more or different power supplies, and with additional portable generators as needed.

Further, the output voltage from each power supply could vary. For example, for a 20 kW unit, the output voltage of each 5 kW power supply could be about 250V DC, the total output voltage could be about 1000 VDC and each power supply would operate at about 20 A.

Further, it will be understood that in the Time-domain EM (TDEM) method, the transmitter loop size, the loop location, and the peak current carried by the loop are very important survey parameters which must be considered carefully. Putting more current through the loop increases the primary magnetic field strength, which is generally a good thing as it creates stronger eddy currents in the ground which makes the secondary magnetic field stronger and easier to measure. However, changing the location or size of the loop is often more important, because the location determines the best coupling with the target conductor, and larger loop sizes produce primary magnetic fields that decrease more slowly with depth, so deep exploration requires the use of large loops. Accordingly, a single transmitter that can accommodate various loop sizes while maximizing peak current and portability is useful for TDEM.

The following examples show the flexibility of the system:
1. A survey might require only a small, 100 m×100 m square transmit loop because only the top 100 m of the earth is being explored. In this case, #10 AWG wire would give 1.3 ohms resistance. This would require 60 A peak current through this loop at 78V and 4.7 kW of power. This could be accommodated through a single 5 kW motor generator.
2. If anomalous readings are suspected to be caused by a deep conductor with the configuration described in 1., a follow-up survey might be started immediately by increasing the loop size to 400 m×400 m which will produce a stronger primary field at greater depth, and therefore provide better definition of the target. There would be at least two options:
   2a) Maintain portability by using a single motor generator. The loop resistance for a 400 m×400 m loop of #10 AWG wire would be 5.25 ohms, so 30 Amps could be put through it at 158V, requiring 4.7 kW of power, supplied by a single motor generator.
   2b) Maximize the current at 60 A. The loop resistance would be 5.25 ohms, so 60 Amps could be put through it at 315V, requiring 18.9 kW of power, supplied by four motor generators.
3. If a greater depth of exploration is desired at this site with even larger loops, a single motor generator could supply 5 kW power at 250V and 20 Amps. The resistive load of 12.5 ohms would allow a loop of size 900 m×900 m to be used. Alternatively, the 900 m×900 m loop could carry 25 A (at 300V and 7.5 kW) by using two motor generators; 35 A (at 420V and 14.7 kW) by using three motor generators; or 40 A (at 480V and 19.2 kW) by using four motor generators.
4. If a very large loop is desired, #12 AWG wire might be used. With such wire, for example, a 2.5 km by 2.5 km square loop of wire would have a resistance of 52.5 ohms (as opposed to 33 ohms for #10 AWG wire), and 19 A of current could be put through the loop at 998V and 18.9 kW power.

Important, the above examples show how a typical exploration program might evolve while the survey is progressing, and the 20 kW transmitter would be able to handle all of the changes to the survey parameters simply by bringing in additional off-the-shelf motor generators. Previously, different transmitters would have to be sourced and brought in, which would delay the program, and bringing in transmitters of 15 kW or more would have added exorbitant costs if helicopter deployment had to be used due to access issues.

As a final example of the flexibility of the new 20 kW system, a situation might arise where access to the work site is not an issue, and a large, single 20 kW or larger motor generator is available to be used. In that case, the 20 kW transmitter could still be used, with each 5 kW power supply powered by a separate cable to the large, single generator.

Finally, whereas the transmitter described is used with a Time-domain Electromagnetic (TDEM) system, other geophysical systems such as electromagnetic (EM) systems, Induced Polarization (IP) systems and Resistivity systems, can be so employed.

1.-15. (canceled)

16. A system comprising:
a plurality of DC generators, each DC generator being defined by a portable single phase AC generator and a power supply, the power supply being releasably coupled to said AC generator to receive AC power therefrom and produce DC power;
circuitry coupling the DC generators together such that the power supplies thereof are connected in series to define a DC supply;
a portable transmitter operatively releasably coupled to the DC supply; and
a TDEM loop operatively coupled to the transmitter.

17. A system according to claim 16, wherein each power supply is a nominal 5 kW power supply adapted to receive single phase AC power and rated for about 60 A and about 170 VDC

18. A system according to claim 17, wherein the transmitter has a power of about 15 kW.

19. A system according to claim 18, wherein each generator is a 5 or 6 kW single phase AC generator, rated for about 240 VAC and about 20 Amps.

20. A system according to claim 18, further comprising a housing containing the power supplies and the circuitry, the generators and TDEM loop being disposed exterior to the housing.

21. A system according to claim 20, wherein the transmitter is disposed exterior to the housing.
